(19) United States
(12) Patent Application Publication
(10) Pub. No.: US 2026/0369463 A1
(43) Pub. Date: Nov. 19, 2026

(54) ELECTRONIC COMPONENT

(71) Applicant: TDK Corporation, Tokyo (JP)

(72) Inventors: Takuma SAKAIYA, Tokyo (JP); Yuto SHIGA, Tokyo (JP); So KOBAYASHI, Tokyo (JP); Hiroto KOMATSU, Tokyo (JP); Teru ISHIMORI, Tokyo (JP)

(73) Assignee: TDK Corporation, Tokyo (JP)

(21) Appl. No.: 19/658,883

(22) Filed: Apr. 27, 2026

(30) Foreign Application Priority Data
May 16, 2025 (JP) 2025-082468

(51) Int. Cl. H01F 27/29; H01F 17/02; H01F 27/32

(52) U.S. Cl. CPC H01F 27/292; H01F 17/02; H01F 27/327

(57) ABSTRACT

An electronic component includes an element body and an external electrode. The element body includes first and second main surfaces opposing each other and a pair of end surfaces adjacent to the first and second main surfaces and opposing each other. The external electrode is disposed on the element body and includes a first conductor portion, a second conductor portion, and at least one third conductor portion. The first conductor portion is embedded in the element body and is partially exposed at the first main surface. The second conductor portion is embedded in the element body and is partially exposed at a corresponding end surface of the pair of end surfaces. The at least one third conductor portion is embedded in the element body, and is continuous with the first conductor portion and the second conductor portion to couple the first conductor portion to the second conductor portion.

### CROSS-REFERENCE TO RELATED APPLICATIONS

This application is based upon and claims the benefit of priority from Japanese Patent Application No. 2025-082468, filed on May 16, 2025, the entire contents of which are incorporated herein by reference.

### BACKGROUND

### Field

An aspect of the present disclosure relates to an electronic component.

### Description of the Related Art

Known electronic components include an element body and a pair of external electrodes disposed on the element body (see, for example, International Publication No. 2016/006542). Each of the pair of external electrodes is embedded in the element body and is partially exposed at a surface of the element body.

### SUMMARY

An electronic component according to an aspect of the present disclosure includes an element body and a pair of external electrodes disposed on the element body. The element body includes a first main surface arranged to constitute a mounting surface, a second main surface opposing the first main surface, a pair of end surfaces adjacent to both the first main surface and the second main surface, and opposing each other, and a pair of side surfaces adjacent to both the first main surface, the second main surface, and the pair of end surfaces, and opposing each other. Each of the pair of external electrodes includes a plate-shaped first conductor portion embedded in the element body and partially exposed at the first main surface, a plate-shaped second conductor portion embedded in the element body and partially exposed at a corresponding end surface of the pair of end surfaces, and at least one third conductor portion embedded in the element body, the at least one third conductor portion being continuous with the first conductor portion and the second conductor portion to connect the first conductor portion and the second conductor portion.

### BRIEF DESCRIPTION OF THE DRAWINGS

FIG. 1 is a perspective view illustrating a coil component according to an example;

FIG. 2 is a perspective view illustrating a coil and external electrodes;

FIG. 3 is an exploded plan view illustrating the coil component;

FIG. 4 is a schematic diagram illustrating a cross-sectional configuration of the coil component;

FIG. 5 is a schematic plan view illustrating the external electrodes;

FIG. 6 is a perspective view illustrating a coil and external electrodes;

FIG. 7 is an exploded plan view illustrating a coil component;

FIG. 8 is a schematic plan view illustrating an external electrode;

FIG. 9 is a perspective view illustrating a coil and external electrodes;

FIG. 10 is an exploded plan view illustrating a coil component;

FIG. 11 is a schematic plan view illustrating the external electrodes;

FIG. 12 is a perspective view illustrating a coil and external electrodes;

FIG. 13 is an exploded plan view illustrating a coil component;

FIG. 14 is a schematic plan view illustrating the external electrodes;

FIG. 15 is a perspective view illustrating a coil and external electrodes;

FIG. 16 is an exploded plan view illustrating a coil component;

FIG. 17 is a schematic plan view illustrating the external electrodes;

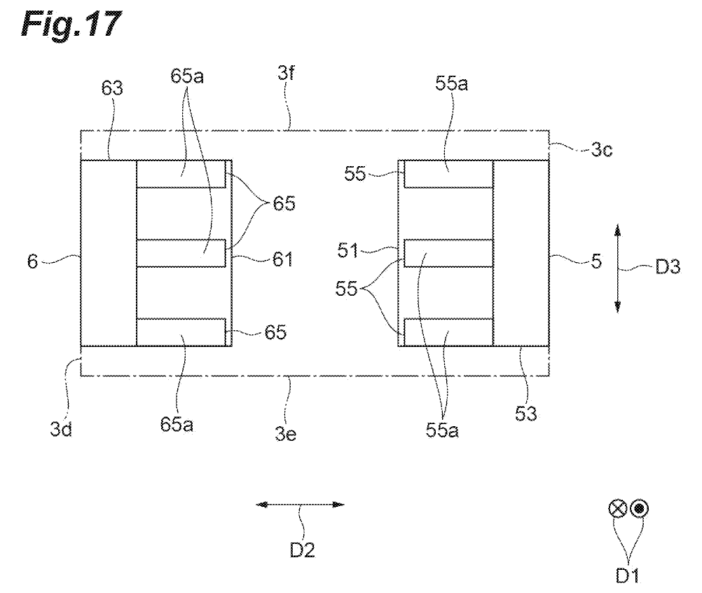

FIG. 18 is a schematic diagram illustrating a cross-sectional configuration of a coil component;

FIG. 19 is a schematic diagram illustrating a cross-sectional configuration of a coil component; and

FIG. 20 is a schematic diagram illustrating a cross-sectional configuration of a coil component.

### DETAILED DESCRIPTION

Hereinafter, various examples of the present disclosure will be described in detail, including examples illustrated in the accompanying drawings. In the following description, with reference to the drawings, the same reference numbers are assigned to the same components or to similar components having the same function, and overlapping description is omitted.

An aspect of the present disclosure provides an electronic component that improves bonding strength between each of a pair of external electrodes and an element body.

An aspect of the present disclosure relates to an electronic component that includes an element body and a pair of external electrodes disposed on the element body. The element body includes a first main surface arranged to constitute a mounting surface, a second main surface opposing the first main surface, a pair of end surfaces adjacent to both the first main surface and the second main surface, and opposing each other, and a pair of side surfaces adjacent to both the first main surface, the second main surface, and the pair of end surfaces, and opposing each other. Each of the pair of external electrodes includes a plate-shaped first conductor portion embedded in the element body and partially exposed at the first main surface, a plate-shaped second conductor portion embedded in the element body and partially exposed at a corresponding end surface of the pair of end surfaces, and at least one third conductor portion embedded in the element body, the at least one third conductor portion being continuous with the first conductor portion and the second conductor portion to connect the first conductor portion and the second conductor portion.

In the above aspect, each of the pair of external electrodes includes not only the first conductor portion and the second conductor portion but also the third conductor portion. Therefore, the above aspect increases a contact area between the element body and each of the pair of external electrodes, as compared with a configuration in which each external electrode does not include the third conductor portion. Consequently, the above aspect improves bonding strength between each of the pair of external electrodes and the element body.

The above aspect may include a coil disposed in the element body and electrically connected to the pair of external electrodes, the coil including a plurality of coil conductors.

An electronic component including a coil may be a coil component. Therefore, even with the electronic component being a coil component, the bonding strength between each of the pair of external electrodes and the element body is improved.

In the above aspect, a coil conductor, among the plurality of coil conductors, disposed at a same position as the at least one third conductor portion in a direction in which the pair of side surfaces oppose each other may includes a first portion located closer to one of the pair of end surfaces than a plane orthogonal to the first main surface and parallel to the pair of end surfaces, the plane including an axis of the coil, and a second portion located closer to the other of the pair of end surfaces than the plane. The at least one third conductor portion may be disposed to oppose whichever of the first portion and the second portion has the smaller length.

A configuration in which the at least one third conductor portion is disposed to oppose whichever of the first portion and the second portion has the smaller length tends to reduce an opposing area between the at least one third conductor portion and the coil conductor including the first portion and the second portion, as compared with a configuration in which the at least one third conductor portion is disposed to oppose whichever of the first portion and the second portion has the larger length. Therefore, in the configuration in which the at least one third conductor portion is disposed to oppose whichever of the first portion and the second portion has the smaller length, this configuration suppresses an increase in stray capacitance between the external electrode and the coil, and tends not to degrade characteristics of the electronic component.

In the above aspect, a coil conductor, among the plurality of coil conductors, disposed at a same position as the at least one third conductor portion in a direction in which the pair of side surfaces oppose each other may be located closer to the second main surface than a plane parallel to the first main surface and including an end of the at least one third conductor portion included in each of the pair of external electrodes, the end being farthest from the first main surface.

In a configuration in which the coil conductor, among the plurality of coil conductors, disposed at the same position as the at least one third conductor portion in the direction in which the pair of side surfaces oppose each other is located closer to the second main surface as described above, this configuration tends to reduce the opposing area between the at least one third conductor portion and the coil conductor disposed at the same position as the at least one third conductor portion. Therefore, this configuration suppresses an increase in stray capacitance between the external electrode and the coil, and tends not to degrade characteristics of the electronic component.

In the above aspect, a width of the at least one third conductor portion in a direction in which the pair of end surfaces oppose each other may decrease as distance from the first main surface increases.

A configuration in which the above-described width decreases as distance from the first main surface increases tends not to decrease the distance between the at least one third conductor portion and the coil. Therefore, this configuration suppresses an increase in stray capacitance generated between the external electrode and the coil, and tends not to degrade characteristics of the electronic component.

In the above aspect, the at least one third conductor portion may include a surface opposing the coil. A distance, in a direction in which the pair of end surfaces oppose each other, between the surface opposing the coil in the at least one third conductor portion and the corresponding end surface may decrease as distance from the first main surface increases.

A configuration in which the above-described distance decreases as distance from the first main surface increases tends not to decrease the distance between the at least one third conductor portion and the coil. Therefore, this configuration suppresses an increase in stray capacitance generated between the external electrode and the coil, and tends not to degrade characteristics of the electronic component.

In the above aspect, the at least one third conductor portion may include a plurality of third conductor portions spaced apart from each other in a direction in which the pair of side surfaces oppose each other.

A configuration in which the at least one third conductor portion includes the above-described plurality of third conductor portions further increases the contact area between the element body and each of the pair of external electrodes. Therefore, this configuration further improves the bonding strength between each of the pair of external electrodes and the element body.

In the above aspect, each of the pair of external electrodes may include a plurality of first conductor layers each including a corresponding third conductor portion among the plurality of third conductor portions, and a plurality of second conductor layers not including the third conductor portion. The plurality of first conductor layers and the plurality of second conductor layers may be alternately disposed in the direction in which the pair of side surfaces oppose each other.

A configuration in which the plurality of first conductor layers and the plurality of second conductor layers are alternately disposed in the direction in which the pair of side surfaces oppose each other more reliably increases the contact area between the element body and each of the pair of external electrodes. Therefore, this configuration more reliably improves the bonding strength between each of the pair of external electrodes and the element body.

In the above aspect, the at least one third conductor portion may be located at an outermost position in the external electrode in a direction in which the pair of side surfaces oppose each other.

In the above aspect, the at least one third conductor portion included in one of the pair of external electrodes and the at least one third conductor portion included in the other of the pair of external electrodes may be disposed at different positions in a direction in which the pair of side surfaces oppose each other.

In the above aspect, the first conductor portion and the second conductor portion may be directly connected to each other.

A configuration in which the first conductor portion and the second conductor portion are directly connected to each other further increases the contact area between the element body and each of the pair of external electrodes. Therefore, this configuration further improves the bonding strength between each of the pair of external electrodes and the element body.

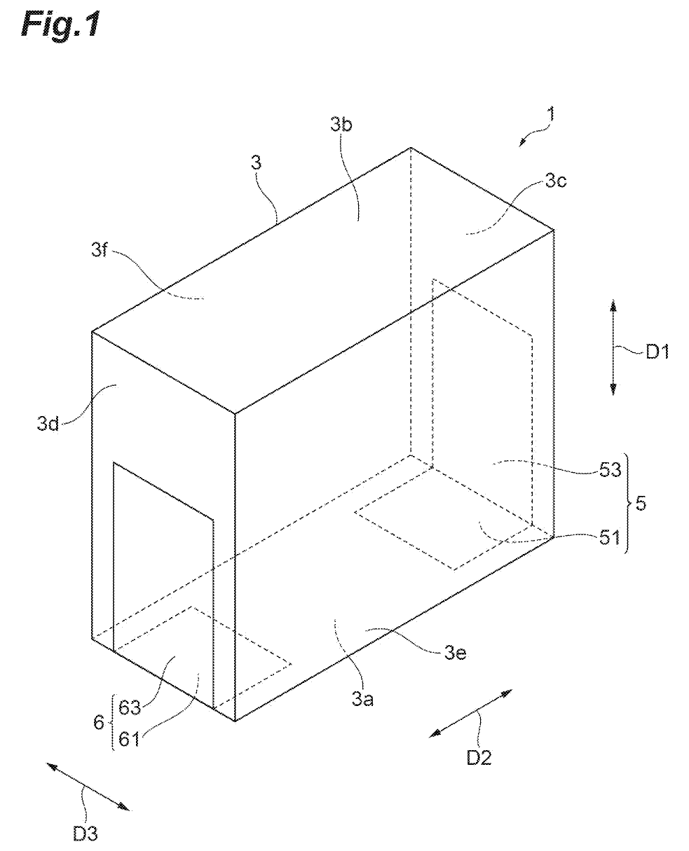

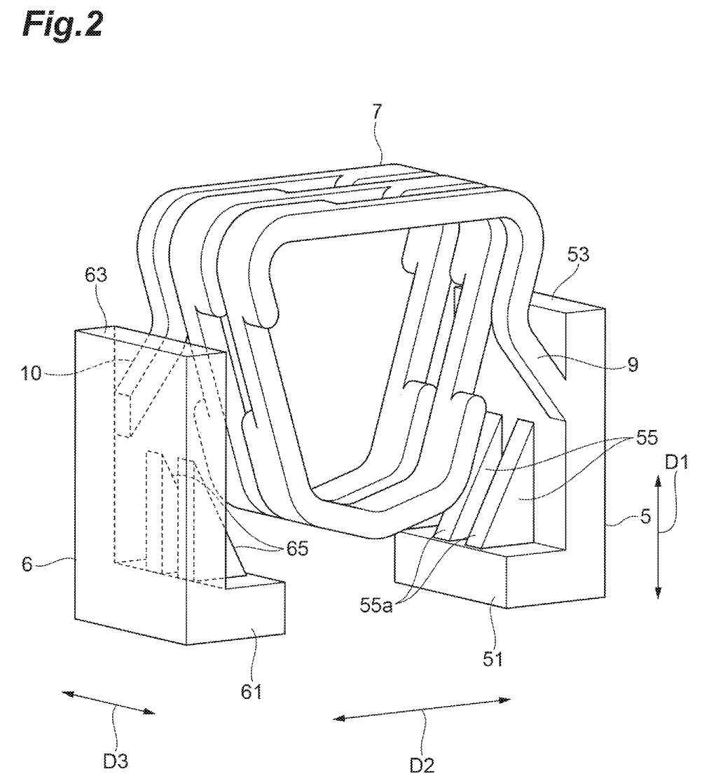

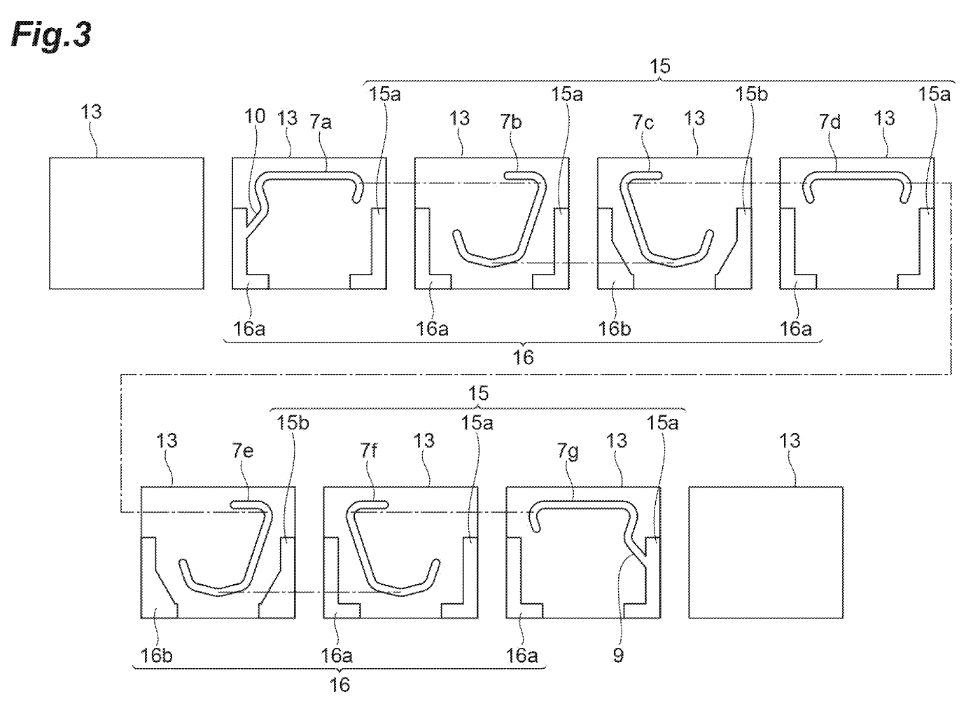

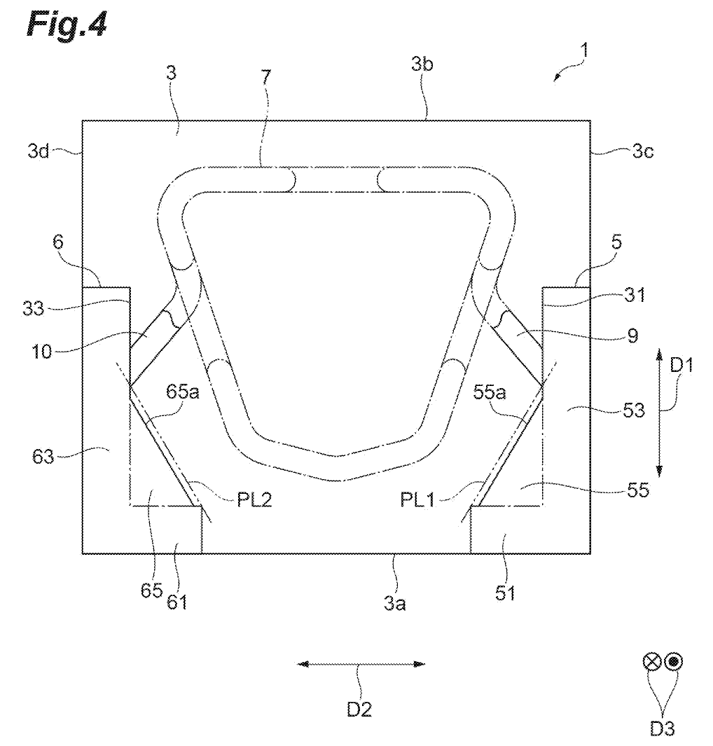

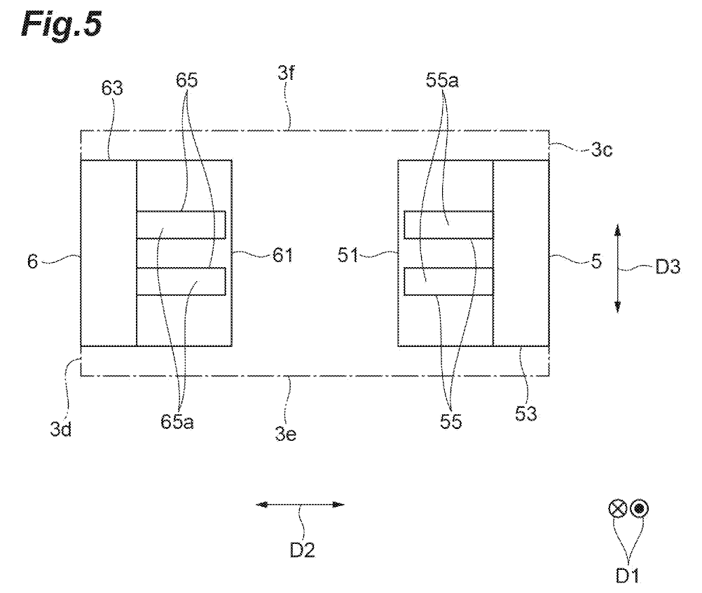

A configuration of an electronic component according to the present example will be described with reference to FIGS. 1 - 5. The electronic component includes, for example, a coil component 1. FIG. 1 is a perspective view illustrating the coil component according to the present example. FIG. 2 is a perspective view illustrating a coil and external electrodes. FIG. 3 is an exploded plan view illustrating the coil component. FIG. 4 is a schematic diagram illustrating a cross-sectional configuration of the coil component. FIG. 5 is a schematic plan view illustrating the external electrodes. In FIG. 4, hatching indicating the cross-sections is omitted.

As illustrated in FIGS. 1 - 5, the coil component 1 includes an element body 3, a plurality of external electrodes 5 and 6, a coil 7, and a plurality of connection conductors 9 and 10. The coil component 1 includes, for example, two external electrodes 5 and 6. The coil component 1 includes, for example, two connection conductors 9 and 10. The coil component 1 includes, for example, a multilayer coil component.

The element body 3 has, for example, a rectangular parallelepiped shape. The rectangular parallelepiped shape includes, for example, a shape of a rectangular parallelepiped in which corners and ridges are chamfered, or a shape of a rectangular parallelepiped in which corners and ridges are rounded. The element body 3 includes a pair of main surfaces 3a and 3b, a pair of end surfaces 3c and 3d, and a pair of side surfaces 3e and 3f. The pair of main surfaces 3a and 3b oppose each other in a direction D1. The pair of end surfaces 3c and 3d oppose each other in a direction D2. The pair of side surfaces 3e and 3f oppose each other in a direction D3. The direction D1, the direction D2, and the direction D3 are, for example, substantially orthogonal to each other. For example, the main surface 3a may include the first main surface, and the main surface 3b may include the second main surface.

The pair of main surfaces 3a and 3b and the pair of end surfaces 3c and 3d are adjacent to each other. The pair of main surfaces 3a and 3b and the pair of side surfaces 3e and 3f are adjacent to each other. The pair of end surfaces 3c and 3d and the pair of side surfaces 3e and 3f are adjacent to each other.

The pair of main surfaces 3a and 3b extend in the direction D2 to couple the pair of end surfaces 3c and 3d. The pair of main surfaces 3a and 3b extend in the direction D3 to couple the pair of side surfaces 3e and 3f. The pair of end surfaces 3c and 3d extend in the direction D1 to couple the pair of main surfaces 3a and 3b. The pair of end surfaces 3c and 3d extend in the direction D3 to couple the pair of side surfaces 3e and 3f. The pair of side surfaces 3e and 3f extend in the direction D1 to couple the pair of main surfaces 3a and 3b. The pair of side surfaces 3e and 3f extend in the direction D2 to couple the pair of end surfaces 3c and 3d.

The coil component 1 is mounted on an electronic device. For example, the coil component 1 is solder-mounted on an electronic device. The electronic device includes, for example, a circuit board or another electronic component. In the coil component 1, for example, the main surface 3a opposes the electronic device. The main surface 3a is arranged to constitute a mounting surface. The main surface 3a includes the mounting surface.

As illustrated in FIG. 3, the element body 3 is configured by laminating a plurality of element body layers 13. The element body 3 includes the plurality of laminated element body layers 13. In the element body 3, the lamination direction of the plurality of element body layers 13 coincides with the direction D3. In the actual element body 3, the plurality of element body layers 13 may be integrated to such a degree that the boundaries between the layers are not visible, or may be integrated such that the boundaries between the layers are visible. The plurality of element body layers 13 include an electrical insulator. The plurality of element body layers 13 are made of an electrical insulator. The electrical insulator includes, for example, a non-magnetic material. The element body 3 is made of, for example, an electrical insulator. The non-magnetic material includes, for example, a glass ceramic. The element body 3 is made of, for example, a glass ceramic. The electrical insulator may include a magnetic material.

As illustrated in FIG. 4, the external electrode 5 is disposed in a recess 31 defined in the element body 3. The recess 31 has a shape corresponding to the external electrode 5. The external electrode 5 is disposed in the recess 31 such that the external electrode 5 is partially exposed at the main surface 3a and the end surface 3c. The external electrode 6 is disposed in a recess 33 defined in the element body 3. The recess 33 has a shape corresponding to the external electrode 6. The external electrode 6 is disposed in the recess 33 such that the external electrode 6 is partially exposed on the main surface 3a and the end surface 3d. The external electrode 5 and the external electrode 6 are spaced apart from each other in the direction D2.

Each of the plurality of external electrodes 5 and 6 includes a portion located within the element body 3 and a surface exposed at the element body 3. A plating layer may be disposed on the surface of each of the plurality of external electrodes 5 and 6 exposed at the element body 3. The plating layer is formed through, for example, an electrolytic plating process or an electroless plating process. The plating layer includes, for example, Ni, Sn, or Au.

The coil 7 is disposed in the element body 3. The coil 7 is disposed such that the coil axis extends along the direction D3. The coil 7 has, for example, a polygonal shape in a view along the direction D3. The coil 7 has, for example, a pentagonal shape in a view along the direction D3. The coil 7 may have a circular shape in a view along the direction D3.

As illustrated in FIG. 3, the coil 7 includes a plurality of coil conductors 7a, 7b, 7c, 7d, 7e, 7f, and 7g. For example, the coil 7 includes seven coil conductors 7a, 7b, 7c, 7d, 7e, 7f, and 7g. The plurality of coil conductors 7a, 7b, 7c, 7d, 7e, 7f, and 7g are spaced apart from both the pair of main surfaces 3a and 3b, the pair of end surfaces 3c and 3d, and the pair of side surfaces 3e and 3f.

Each of the plurality of coil conductors 7a, 7b, 7c, 7d, 7e, 7f, and 7g has, for example, a shape in which a part of a loop is interrupted. Each of the plurality of coil conductors 7a, 7b, 7c, 7d, 7e, 7f, and 7g has, for example, a shape that includes a pair of ends and substantially extends between the pair of ends along an annular path. The term "annular" as used herein includes, for example, a polygonal shape or a circular shape. The polygonal shape includes, for example, a shape with rounded corners. The circular shape includes, for example, a perfect circle shape or an oval shape. The coil conductor 7a includes one end of the coil 7. The coil conductor 7g includes the other end of the coil 7.

The plurality of coil conductors 7a, 7b, 7c, 7d, 7e, 7f, and 7g are disposed in the direction D3 such that the coil axis extends along the direction D3. Coil conductors adjacent to each other in the direction D3, among the plurality of coil conductors 7a, 7b, 7c, 7d, 7e, 7f, and 7g, are disposed such that at least portions thereof overlap each other in a view along the direction D3. Coil conductors adjacent to each other in the direction D3, among the plurality of coil conductors 7a, 7b, 7c, 7d, 7e, 7f, and 7g, are directly connected to each other, for example. Coil conductors adjacent to each other in the direction D3 are, for example, formed integrally with each other. The plurality of coil conductors 7a, 7b, 7c, 7d, 7e, 7f, and 7g are electrically connected to each other. Coil conductors adjacent to each other in the direction D3 may be indirectly connected to each other through a via conductor.

The plurality of connection conductors 9 and 10 are disposed in the element body 3.

The connection conductor 9 couples the external electrode 5 to the coil 7. For example, the connection conductor 9 is directly connected to the external electrode 5 and the coil 7. For example, the connection conductor 9 is directly connected to the coil conductor 7a. The connection conductor 9 is connected to one end of the coil 7. The connection conductor 9 is formed, for example, integrally with the coil conductor 7a. The connection conductor 9 electrically connects the external electrode 5 and the coil 7.

The connection conductor 10 couples the external electrode 6 to the coil 7. For example, the connection conductor 10 is directly connected to the external electrode 6 and the coil 7. For example, the connection conductor 10 is directly connected to the coil conductor 7g. The connection conductor 10 is connected to the other end of the coil 7. The connection conductor 10 is formed, for example, integrally with the coil conductor 7g. The connection conductor 10 electrically connects the external electrode 6 and the coil 7. The coil 7 is electrically connected to the plurality of external electrodes 5 and 6.

Each of the plurality of coil conductors 7a, 7b, 7c, 7d, 7e, 7f, and 7g is disposed in a corresponding one of the plurality of element body layers 13. An opening is formed in the corresponding element body layer 13. The opening has a shape corresponding to the shape of the corresponding coil conductor among the plurality of coil conductors 7a, 7b, 7c, 7d, 7e, 7f, and 7g. The corresponding coil conductor is located in the opening.

Each of the plurality of connection conductors 9 and 10 is disposed in a corresponding one of the plurality of element body layers 13. An opening is formed in the corresponding element body layer 13. The opening has a shape corresponding to the shape of the corresponding connection conductor among the plurality of connection conductors 9 and 10. The corresponding connection conductor is located in the opening.

The element body 3 includes, for example, an inner layer region and a pair of outer layer regions. The plurality of coil conductors 7a, 7b, 7c, 7d, 7e, 7f, and 7g are disposed in the inner layer region. The pair of outer layer regions are located on opposite sides of the inner layer region. That is, the pair of outer layer regions are disposed with the inner layer region interposed therebetween. Each of the pair of outer layer regions includes a corresponding one of the pair of side surfaces 3e and 3f. The plurality of coil conductors 7a, 7b, 7c, 7d, 7e, 7f, and 7g are not disposed in each of the pair of outer layer regions.

The external electrode 5 includes a plurality of conductor portions 51 and 53. The external electrode 5 includes, for example, two conductor portions 51 and 53. The conductor portion 51 is embedded in the element body 3 and is partially exposed at the main surface 3a. The conductor portion 51 has a plate shape. The conductor portion 53 is embedded in the element body 3 and is partially exposed at the end surface 3c. The conductor portion 53 has a plate shape. The connection conductor 9 is directly connected to the conductor portion 53.

The conductor portion 51 and the conductor portion 53 are directly connected to each other. The conductor portion 51 and the conductor portion 53 may be spaced apart from each other. The external electrode 5 has, for example, an L-shaped cross-section. The external electrode 5 has, for example, an L-shape in a view along the direction D3. The L-shape may be any shape that has a substantially L-shape as a whole. For example, even with irregularities formed on the surfaces of the conductor portions 51 and 53, the external electrode 5 is considered to has an L-shape provided that the external electrode 5 has an L-shape as a whole.

A corner, located within the element body 3, at an end of the conductor portion 51 may have a rounded shape. The above-described corner of the conductor portion 51 may be curved in a cross-section orthogonal to the direction D3. The above-described end of the conductor portion 51 includes an end in the direction D1.

A corner, located within the element body 3, at an end of the conductor portion 53 may have a rounded shape. The above-described corner of the conductor portion 53 may be curved in a cross-section orthogonal to the direction D3. The above-described end of the conductor portion 53 includes an end in the direction D2.

The external electrode 5 includes at least one conductor portion 55. The external electrode 5 includes, for example, a plurality of conductor portions 55. The plurality of conductor portions 55 are spaced apart from each other in the direction D3. The external electrode 5 includes, for example, two conductor portions 55. The conductor portion 55 is continuous with the conductor portion 51 and the conductor portion 53 to couple the conductor portion 51 to the conductor portion 53. The conductor portion 55 is embedded in the element body 3. The conductor portion 55 is embedded in, for example, the inner layer region of the element body 3. The conductor portion 55 is not exposed at a surface of the element body 3. The conductor portion 55 may have a plate shape. For example, the conductor portion 51 may include the first conductor portion, the conductor portion 53 may include the second conductor portion, and the conductor portion 55 may include the third conductor portion.

The external electrode 5 may include, for example, the following configuration.

The external electrode 5 is configured by laminating a plurality of conductor layers 15. The external electrode 5 includes the plurality of laminated conductor layers 15. In the external electrode 5, the lamination direction of the plurality of conductor layers 15 coincides with the direction D3. Conductor layers 15 adjacent to each other in the direction D3, among the plurality of conductor layers 15, are directly connected to each other, for example. Conductor layers 15 adjacent to each other in the direction D3 are, for example, formed integrally with each other. In the actual external electrode 5, the plurality of conductor layers 15 may be integrated to such a degree that the boundaries between the layers are not visible, or may be integrated such that the boundaries between the layers are visible. The plurality of conductor layers 15 include a conductor layer 15a including a portion corresponding to the conductor portions 51 and 53, and a conductor layer 15b including a portion corresponding to the conductor portions 51, 53, and 55. The conductor layer 15a does not include a portion corresponding to the conductor portion 55. The plurality of conductor layers 15 include at least one conductor layer 15b. For example, the plurality of conductor layers 15 include two conductor layers 15b. For example, the conductor layer 15bmay include the first conductor layer, and the conductor layer 15a may include the second conductor layer.

Each of the plurality of conductor layers 15 is disposed in a corresponding one of the plurality of element body layers 13. An opening is formed in the corresponding element body layer 13. The opening has a shape corresponding to the shape of the corresponding conductor layer 15 among the plurality of conductor layers 15. The corresponding conductor layer 15 is located in the opening. The plurality of openings corresponding to the plurality of conductor layers 15 collectively form the recess 31.

The external electrode 6 includes a plurality of conductor portions 61 and 63. The external electrode 6 includes, for example, two conductor portions 61 and 63. The conductor portion 61 is embedded in the element body 3 and is partially exposed at the main surface 3a. The conductor portion 61 has a plate shape. The conductor portion 63 is embedded in the element body 3 and is partially exposed at the end surface 3d. The conductor portion 63 has a plate shape. The connection conductor 10 is directly connected to the conductor portion 63.

The conductor portion 61 and the conductor portion 63 are directly connected to each other. The conductor portion 61 and the conductor portion 63 may be spaced apart from each other. The external electrode 6 has, for example, an L-shaped cross-section. The external electrode 6 has, for example, an L-shape in a view along the direction D3. The L-shape may be any shape that has a substantially L-shape as a whole, as described above. For example, even with irregularities formed on the surfaces of the conductor portions 61 and 63, the external electrode 6 is considered to has an L-shape provided that the external electrode 6 has an L-shape as a whole.

A corner, located within the element body 3, at an end of the conductor portion 61 may have a rounded shape. The above-described corner of the conductor portion 61 may be curved in a cross-section orthogonal to the direction D3. The above-described end of the conductor portion 61 includes an end in the direction D1.

A corner, located within the element body 3, at an end of the conductor portion 63 may have a rounded shape. The above-described corner of the conductor portion 63 may be curved in a cross-section orthogonal to the direction D3. The above-described end of the conductor portion 63 includes an end in the direction D2.

The external electrode 6 includes at least one conductor portion 65. The external electrode 6 includes, for example, a plurality of conductor portions 65. The plurality of conductor portions 65 are spaced apart from each other in the direction D3. The external electrode 6 includes, for example, two conductor portions 65. The conductor portion 65 is continuous with the conductor portion 61 and the conductor portion 63 to couple the conductor portion 61 to the conductor portion 63. The conductor portion 65 is embedded in the element body 3. The conductor portion 65 is embedded in, for example, the inner layer region of the element body 3. The conductor portion 65 is not exposed at a surface of the element body 3. The conductor portion 65 may have a plate shape. For example, the conductor portion 61 may include the first conductor portion, the conductor portion 63 may include the second conductor portion, and the conductor portion 65 may include the third conductor portion.

The external electrode 6 may include, for example, the following configuration.

The external electrode 6 is configured by laminating a plurality of conductor layers 16. The external electrode 6 includes the plurality of laminated conductor layers 16. In the external electrode 6, the lamination direction of the plurality of conductor layers 16 coincides with the direction D3. Conductor layers 16 adjacent to each other in the direction D3, among the plurality of conductor layers 16, are directly connected to each other, for example. Conductor layers 16 adjacent to each other in the direction D3 are, for example, formed integrally with each other. In the actual external electrode 6, the plurality of conductor layers 16 may be integrated to such a degree that the boundaries between the layers are not visible, or may be integrated such that the boundaries between the layers are visible. The plurality of conductor layers 16 include a conductor layer 16a including a portion corresponding to the conductor portions 61 and 63, and a conductor layer 16b including a portion corresponding to the conductor portions 61, 63, and 65. The conductor layer 16adoes not include a portion corresponding to the conductor portion 56. The plurality of conductor layers 16 include at least one conductor layer 16b. For example, the plurality of conductor layers 16 include two conductor layers 16b. For example, the conductor layer 16bmay include the first conductor layer, and the conductor layer 16a may include the second conductor layer.

Each of the plurality of conductor layers 16 is disposed in a corresponding one of the plurality of element body layers 13. An opening is formed in the corresponding element body layer 13. The opening has a shape corresponding to the shape of the corresponding conductor layer 16 among the plurality of conductor layers 16. The corresponding conductor layer 16 is located in the opening. The plurality of openings corresponding to the plurality of conductor layers 16 collectively form the recess 33.

One of the two conductor layers 15b is disposed in the element body layer 13 in which the coil conductor 7c is disposed. The other of the two conductor layers 15bis disposed in the element body layer 13 in which the coil conductor 7e is disposed. One of the two conductor portions 55 is disposed at the same position as the coil conductor 7c in the direction D3. The other of the two conductor portions 55 is disposed at the same position as the coil conductor 7e. As illustrated in FIG. 5, the two conductor portions 55 are spaced apart from each other in the direction D3.

As illustrated in FIG. 4, the conductor portion 55 is located within a region defined by the conductor portion 51, the conductor portion 53, and a plane PL1 in a view along the direction D3. The plane PL1 passes through a connection point between the conductor portion 53 and the connection conductor 9, is in contact with the conductor portion 51, and is parallel to the direction D3. An edge of the conductor portion 55 is substantially linear in a view along the direction D3. For example, the conductor portion 55 has a triangular shape in a view along the direction D3.

The conductor portion 55 includes a surface 55a opposing the coil 7. The distance in the direction D2 between the surface 55a of the conductor portion 55 and the end surface 3c decreases as distance from the main surface 3a increases. The surface 55ais inclined relative to a plane orthogonal to the direction D1. The width of the conductor portion 55 in the direction D2 decreases as distance from the main surface 3a increases.

One of the two conductor layers 16b is disposed in the element body layer 13 in which the coil conductor 7c is disposed. The other of the two conductor layers 16bis disposed in the element body layer 13 in which the coil conductor 7e is disposed. One of the two conductor portions 65 is disposed at the same position as the coil conductor 7c in the direction D3. The other of the two conductor portions 65 is disposed at the same position as the coil conductor 7e. As illustrated in FIG. 5, the two conductor portions 65 are spaced apart from each other in the direction D3. The conductor portions 55 are each disposed at the same position as the corresponding conductor portion 65 in the direction D3.

As illustrated in FIG. 4, the conductor portion 65 is located within a region defined by the conductor portion 61, the conductor portion 63, and a plane PL2 in a view along the direction D3. The plane PL2 passes through a connection point between the conductor portion 63 and the connection conductor 10, is in contact with the conductor portion 61, and is parallel to the direction D3. An edge of the conductor portion 65 is substantially linear in a view along the direction D3. For example, the conductor portion 65 has a triangular shape in a view along the direction D3.

The conductor portion 65 includes a surface 65a opposing the coil 7. The distance in the direction D2 between the surface 65a of the conductor portion 65 and the end surface 3d decreases as distance from the main surface 3a increases. The surface 65ais inclined relative to a plane orthogonal to the direction D1. The width of the conductor portion 65 in the direction D2 decreases as distance from the main surface 3a increases.

The plurality of coil conductors 7a, 7b, 7c, 7d, 7e, 7f, and 7g, the plurality of connection conductors 9 and 10, the external electrode 5 (the plurality of conductor layers 15), and the external electrode 6 (the plurality of conductor layers 16) include, for example, an electrically conductive material. The electrically conductive material may include, for example, Ag or Pd. The plurality of coil conductors 7a, 7b, 7c, 7d, 7e, 7f, and 7g, the plurality of connection conductors 9 and 10, the external electrode 5, and the external electrode 6 are configured, for example, as a sintered body of a paste including powder of an electrically conductive material. In this case, the plurality of coil conductors 7a, 7b, 7c, 7d, 7e, 7f, and 7g, the plurality of connection conductors 9 and 10, the external electrode 5, and the external electrode 6 are continuously formed integrally. The plurality of coil conductors 7a, 7b, 7c, 7d, 7e, 7f, and 7g, the plurality of connection conductors 9 and 10, the external electrode 5, and the external electrode 6 may include the same electrically conductive material.

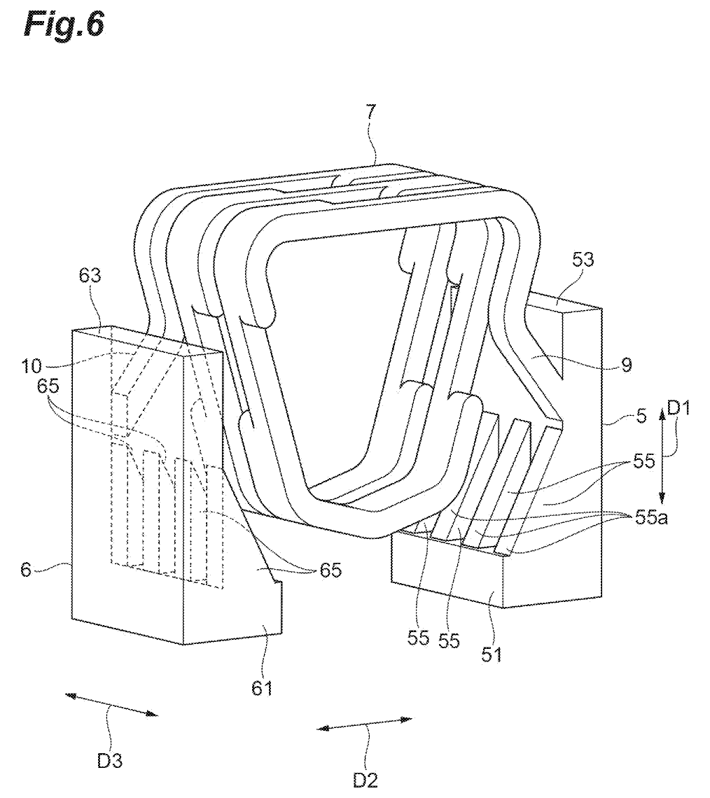

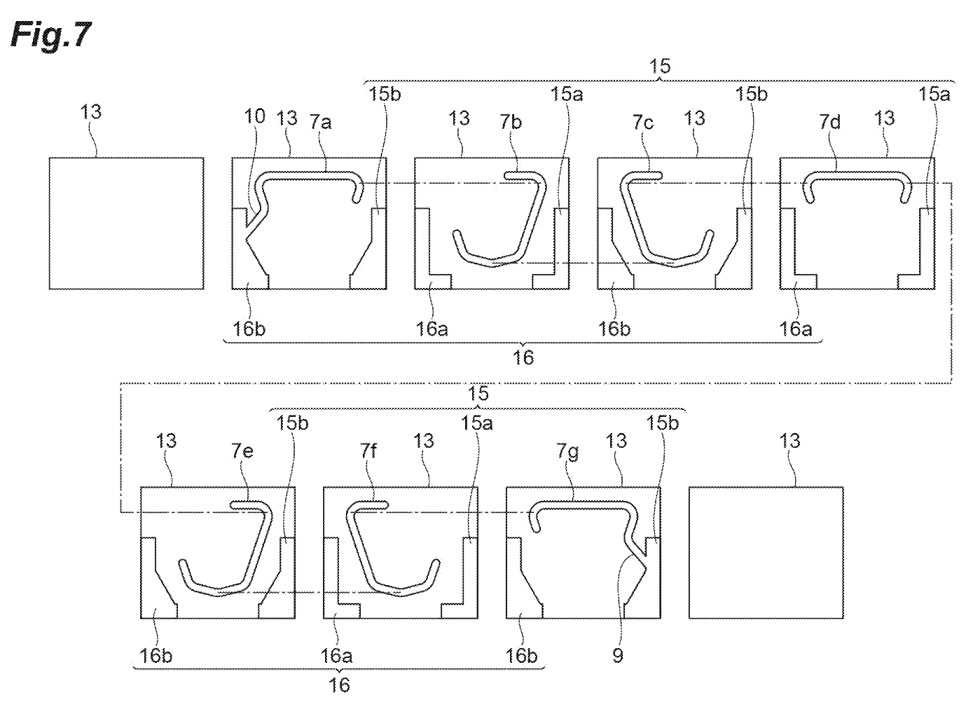

As illustrated in FIGS. 6 and 7, the plurality of conductor layers 15 may include a plurality of conductor layers 15a and a plurality of conductor layers 15b, and the plurality of conductor layers 16 may include a plurality of conductor layers 16a and a plurality of conductor layers 16b. FIG. 6 is a perspective view illustrating a coil and external electrodes. FIG. 7 is an exploded plan view illustrating a coil component.

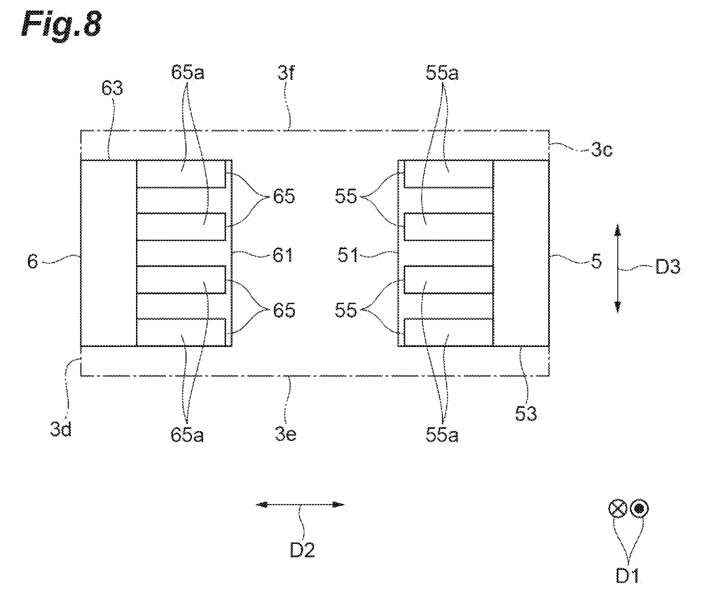

The plurality of conductor layers 15a and the plurality of conductor layers 15b may be alternately disposed in the direction D3. As illustrated in FIG. 8, in a configuration in which the plurality of conductor layers 15a and the plurality of conductor layers 15b are alternately disposed in the direction D3, the plurality of conductor portions 55 are disposed in the direction D3 with a gap between mutually adjacent conductor portions 55. That is, the plurality of conductor portions 55 are arranged in the direction D3 to be spaced apart from each other. FIG. 8 is a schematic plan view illustrating the external electrodes.

The plurality of conductor layers 16a and the plurality of conductor layers 16b may be alternately disposed in the direction D3. In a configuration in which the plurality of conductor layers 16a and the plurality of conductor layers 16b are alternately disposed in the direction D3, the plurality of conductor portions 65 are disposed in the direction D3 with a gap between mutually adjacent conductor portions 65. That is, the plurality of conductor portions 65 are arranged in the direction D3 to be spaced apart from each other. The conductor portions 55 may be each disposed at the same position as the corresponding conductor portion 65 in the direction D3, or may be each disposed at a different position from the corresponding conductor portion 65 in the direction D3.

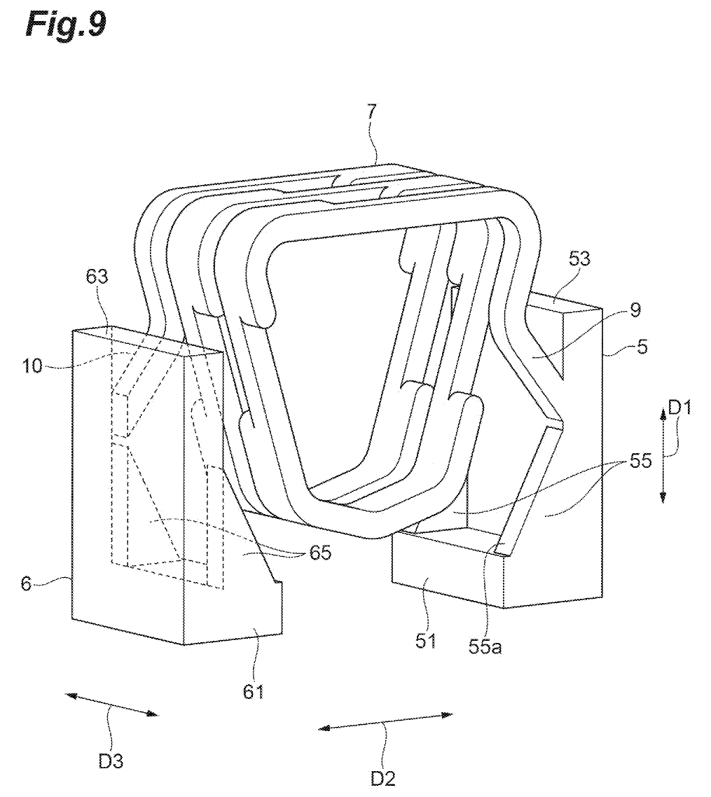

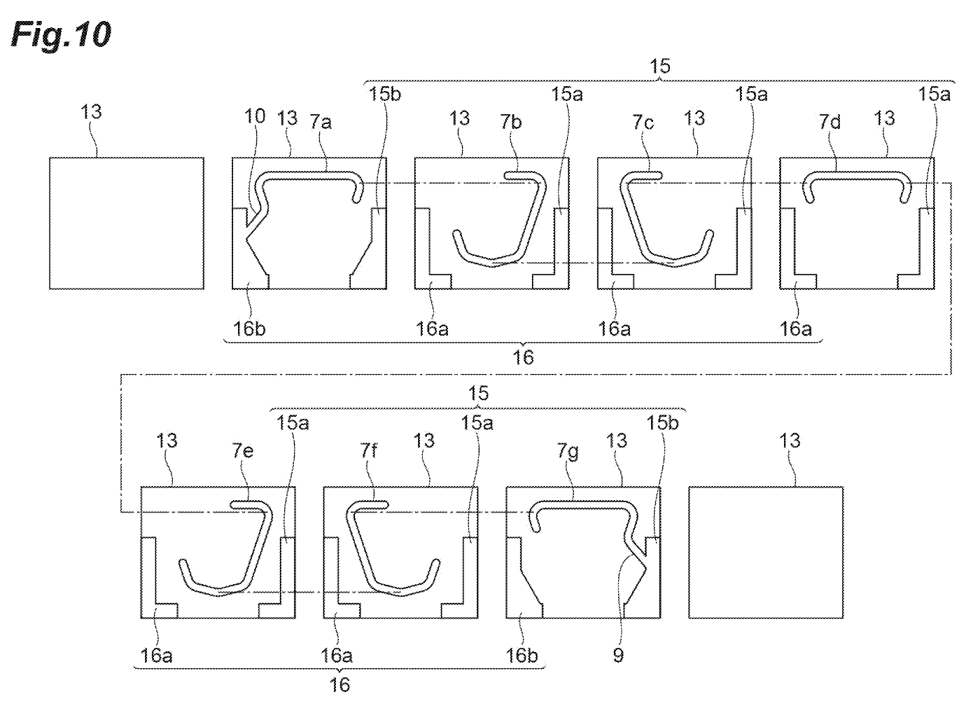

As illustrated in FIGS. 9 and 10, the plurality of conductor layers 15 may include a pair of conductor layers 15b, and the plurality of conductor layers 16 may include a pair of conductor layers 16b. FIG. 9 is a perspective view illustrating a coil and external electrodes. FIG. 10 is an exploded plan view illustrating a coil component.

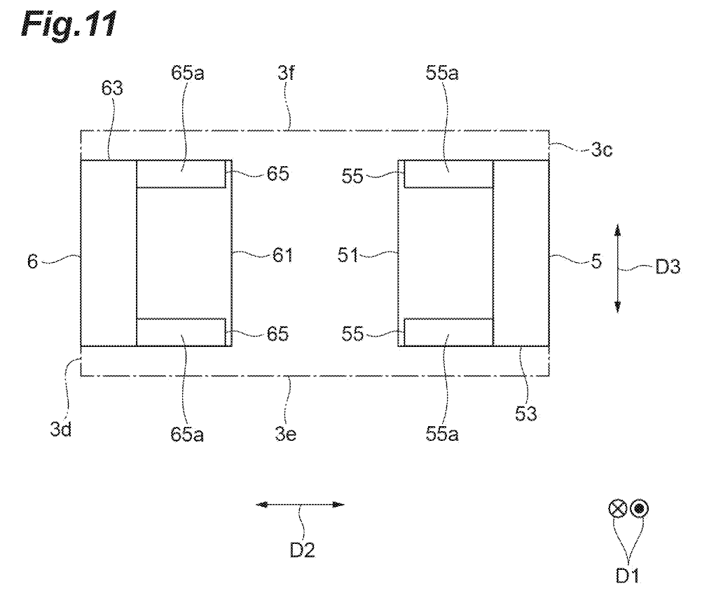

The pair of conductor layers 15b may be located at the outermost positions in the direction D3 among the plurality of conductor layers 15. As illustrated in FIG. 11, in a configuration in which the pair of conductor layers 15b are located at the outermost positions in the direction D3 among the plurality of conductor layers 15, the pair of conductor portions 55 are located at the outermost positions in the direction D3 in the external electrode 5. FIG. 11 is a schematic plan view illustrating external electrodes.

The pair of conductor layers 16b may be located at the outermost positions in the direction D3 among the plurality of conductor layers 16. In a configuration in which the pair of conductor layers 16b are located at the outermost positions in the direction D3 among the plurality of conductor layers 16, the pair of conductor portions 65 are located at the outermost positions in the direction D3 in the external electrode 6.

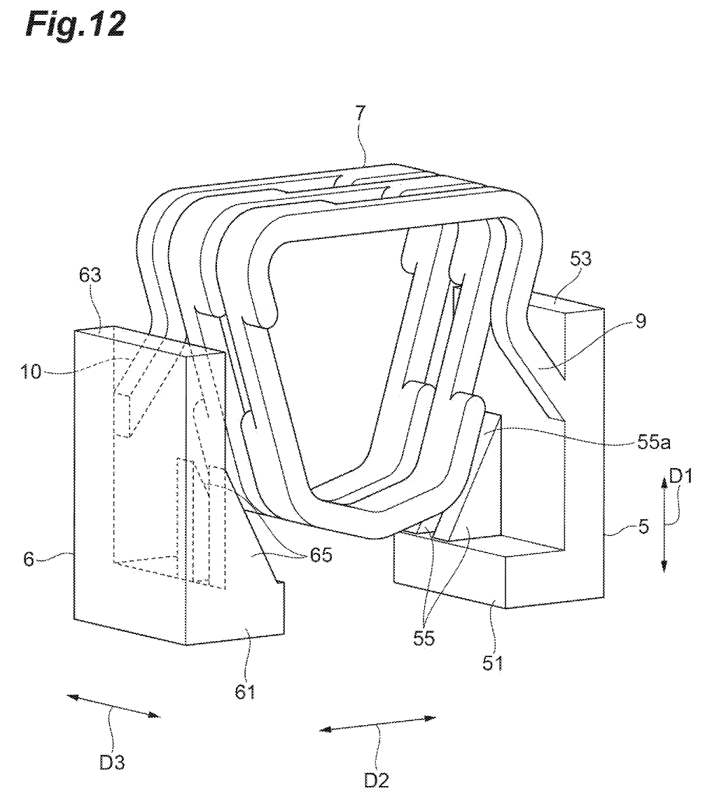

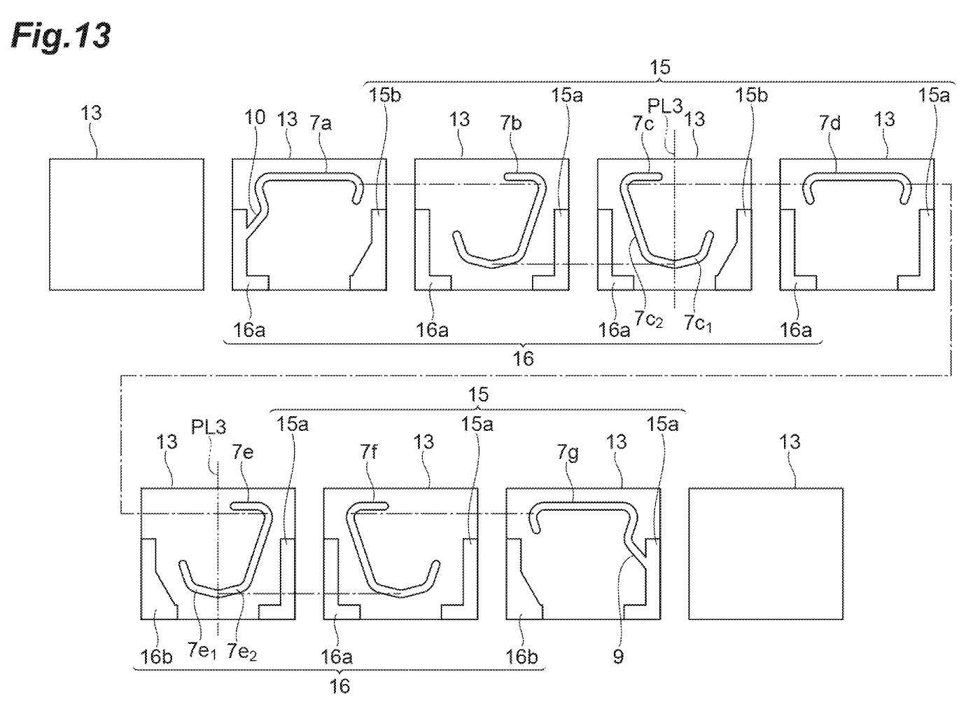

As illustrated in FIGS. 12 and 13, the conductor layer 15b and the conductor layer 16b may be disposed at different positions in the direction D3. That is, the conductor portion 55 and the conductor portion 65 may be disposed at different positions in the direction D3. FIG. 12 is a perspective view illustrating a coil and external electrodes. FIG. 13 is an exploded plan view illustrating a coil component.

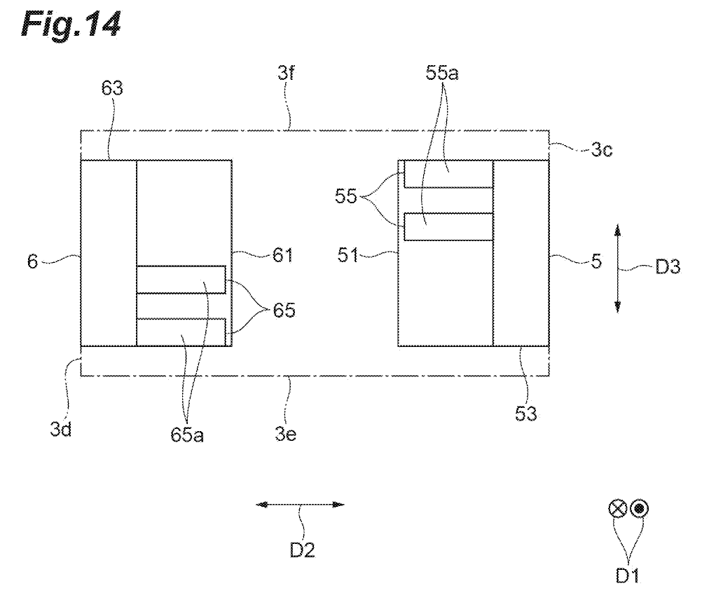

For example, the plurality of conductor layers 15b are located closer to the side surface 3f than the plurality of conductor layers 16b in the direction D3. Therefore, as illustrated in FIG. 14, the conductor portions 55 are located closer to the side surface 3f than the conductor portions 65 in the direction D3. For example, the plurality of conductor layers 16bare located closer to the side surface 3e than the plurality of conductor layers 15b in the direction D3. Therefore, the conductor portions 65 are located closer to the side surface 3e than the conductor portions 55 in the direction D3. FIG. 14 is a schematic plan view illustrating external electrodes.

The coil conductor 7c is disposed at the same position as the conductor layer 15b, that is, the conductor portion 55, in the direction D3. The coil conductor 7c includes a portion 7c₁ and a portion 7c₂. The portion 7c₁ is located closer to the end surface 3c than a plane PL3. The portion 7c₂ is located closer to the end surface 3d than the plane PL3. The plane PL3 is orthogonal to the main surface 3a, is parallel to the pair of end surfaces 3c and 3d, and includes the axis of the coil 7. The length of the portion 7c₁ is smaller than the length of the portion 7c₂. For example, either one of the portion 7c₁and the portion 7c₂ may include the first portion, and the other of the portion 7c₁ and the portion 7c₂ may include the second portion.

The conductor portion 55 disposed at the same position as the coil conductor 7c in the direction D3 is disposed to oppose the portion 7c₁. The conductor portion 65 is not disposed at the same position as the coil conductor 7c in the direction D3.

The coil conductor 7e is disposed at the same position as the conductor layer 16b, that is, the conductor portion 65, in the direction D3. The coil conductor 7e includes a portion 7e₁ and a portion 7e₂. The portion 7e₁ is located closer to the end surface 3d than the plane PL3. The portion 7e₂ is located closer to the end surface 3c than the plane PL3. The length of the portion 7e₁ is smaller than the length of the portion 7e₂. For example, either one of the portion 7e₁ and the portion 7e₂ may include the first portion, and the other of the portion 7e₁ and the portion 7e₂ may include the second portion.

The conductor portion 65 disposed at the same position as the coil conductor 7e in the direction D3 is disposed to oppose the portion 7e₁. The conductor portion 55 is not disposed at the same position as the coil conductor 7e in the direction D3.

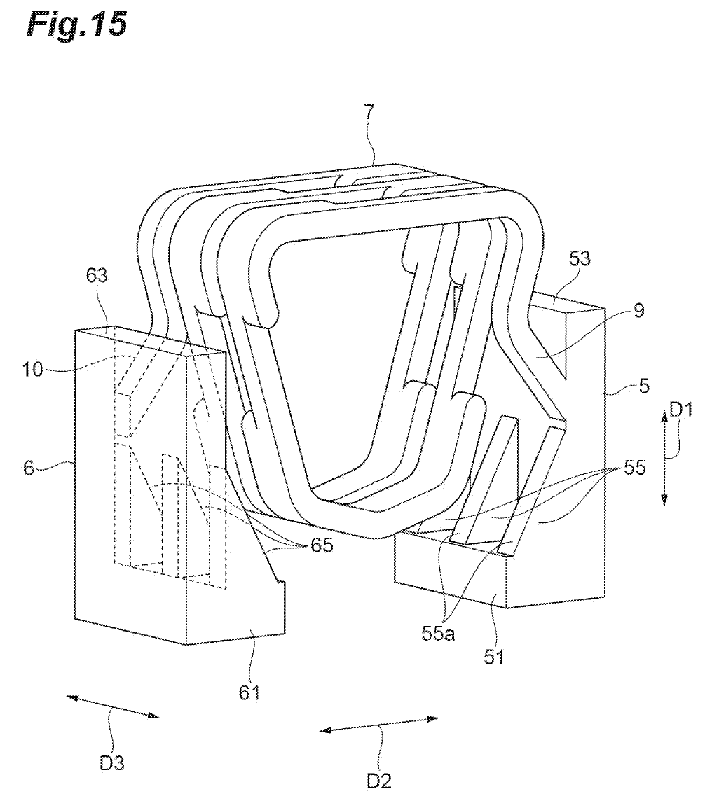

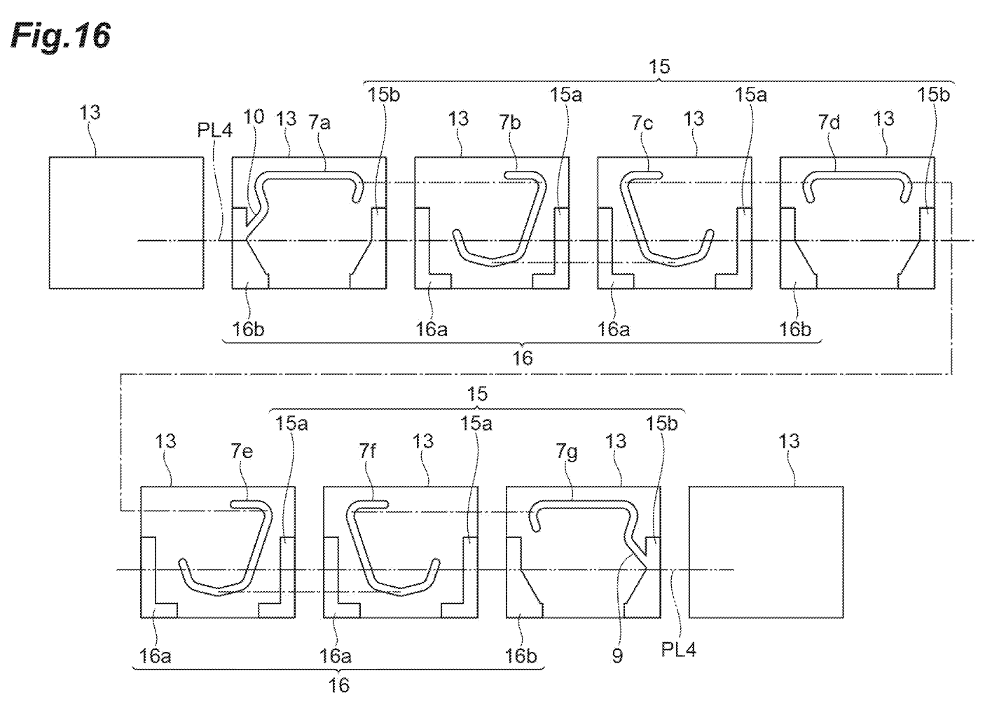

As illustrated in FIGS. 15 and 16, the plurality of conductor layers 15 may include a plurality of conductor layers 15b, and the plurality of conductor layers 16 may include a plurality of conductor layers 16b. For example, the plurality of conductor layers 15 include three conductor layers 15b, and the plurality of conductor layers 16 include three conductor layers 16b. FIG. 15 is a perspective view illustrating a coil and external electrodes. FIG. 16 is an exploded plan view illustrating a coil component.

The conductor layers 15b are each disposed at the same position as the corresponding conductor layer 16b in the direction D3. Therefore, the conductor portions 55 are each disposed at the same position as the corresponding conductor portion 65 in the direction D3.

The coil conductor 7a is disposed at the same position as the conductor portion 55 and the conductor portion 65 in the direction D3. The coil conductor 7d is disposed at the same position as the conductor portion 55 and the conductor portion 65 in the direction D3. The coil conductor 7g is disposed at the same position as the conductor portion 55 and the conductor portion 65 in the direction D3. The coil conductors 7a, 7d, and 7g are located closer to the main surface 3b than a plane PL4. The plane PL4 is parallel to the main surface 3a and includes the ends of the conductor portions 55 and 65 that are farthest from the main surface 3a. The coil conductors 7a, 7d, and 7g are not located closer to the main surface 3a than the plane PL4. The coil conductors 7a, 7d, and 7g do not include any portion located closer to the main surface 3a than the plane PL4.

The coil conductors 7b, 7c, 7e, and 7f include a portion located closer to the main surface 3a than the plane PL4 and a portion located closer to the main surface 3b than the plane PL4. The conductor portion 55 and the conductor portion 65 are not disposed at the same positions as the coil conductors 7b, 7c, 7e, and 7f in the direction D3.

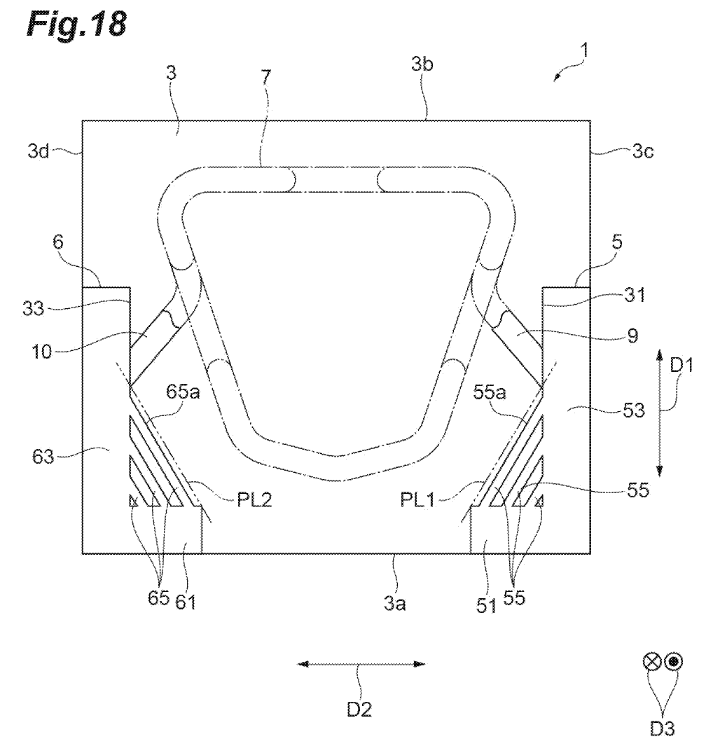

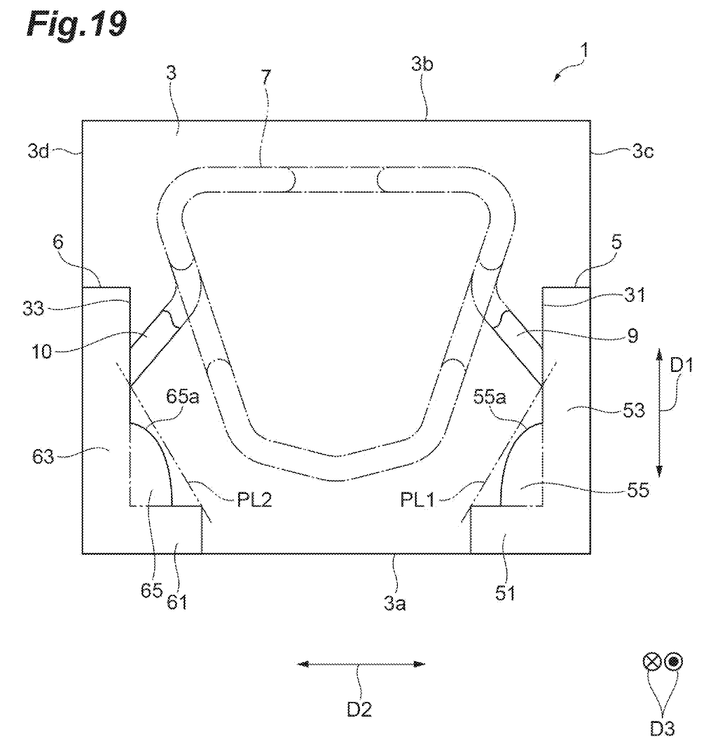

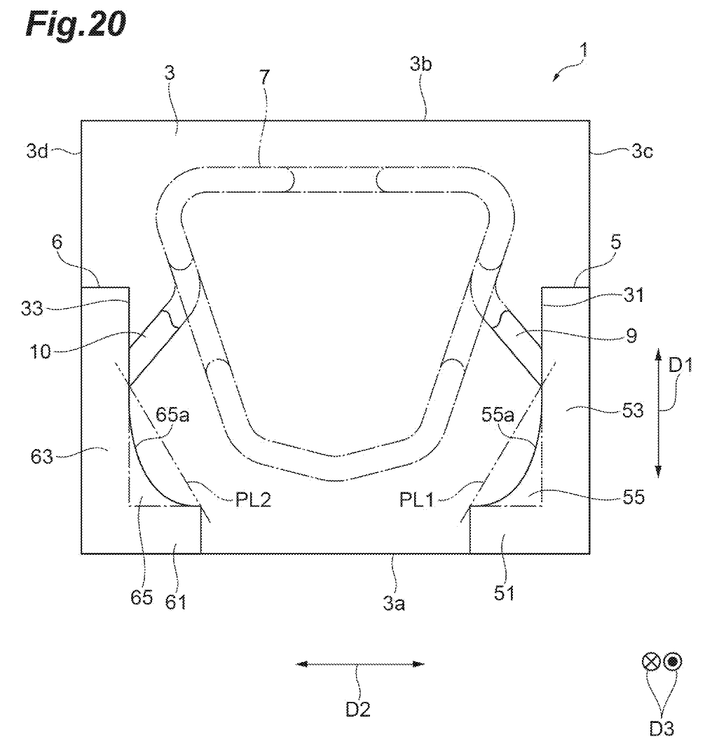

As illustrated in FIG. 18, the conductor portion 55 may include a plurality of portions spaced apart from each other, and the conductor portion 65 may include a plurality of portions spaced apart from each other. As illustrated in FIGS. 19 and 20, the edge of the conductor portion 55 may be substantially arc-shaped in a view along the direction D3, and the edge of the conductor portion 65 may be substantially arc-shaped in a view along the direction D3. FIGS. 18, 19 and 20 are schematic diagrams illustrating cross-sectional configurations of coil components. In FIGS. 18, 19 and 20, hatching indicating the cross-sections is omitted.

In the coil component 1, the external electrode 5 includes not only the conductor portions 51 and 53 but also the conductor portion 55, and the external electrode 6 includes not only the conductor portions 61 and 63 but also the conductor portion 65. Therefore, the coil component 1 increases a contact area between the element body 3 and each of the pair of external electrodes 5 and 6, as compared with a configuration in which the external electrode 5 does not include the conductor portion 55 and the external electrode 6 does not include the conductor portion 65. Consequently, the coil component 1 improves bonding strength between each of the pair of external electrodes 5 and 6 and the element body 3.

The electronic component may include the coil 7. For example, the coil 7 is disposed in the element body 3 and is electrically connected to the pair of external electrodes 5 and 6. The coil 7 may include a plurality of coil conductors 7a, 7b, 7c, 7d, 7e, 7f, and 7g.

An electronic component including the coil 7 may be the coil component 1. Therefore, even with the electronic component being the coil component 1, the bonding strength between each of the pair of external electrodes 5 and 6 and the element body 3 is improved.

The coil conductor 7c disposed at the same position as the conductor portion 55 in the direction D3 may include the portion 7c₁ located closer to the end surface 3c than the plane PL3 and the portion 7c₂ located closer to the end surface 3dthan the plane PL3. The conductor portion 55 may be disposed to oppose the portion 7c₁ having a length smaller than the length of the portion 7c₂.

A configuration in which the conductor portion 55 is disposed to oppose the portion 7c₁ tends to reduce the opposing area between the conductor portion 55 and the coil conductor 7c, as compared with a configuration in which the conductor portion 55 is disposed to oppose the portion 7c₂. Therefore, in the configuration in which the conductor portion 55 is disposed to oppose the portion 7c₁, this configuration suppresses an increase in stray capacitance between the external electrode 5 and the coil 7, and tends not to degrade characteristics of the coil component 1.

For example, a configuration with large stray capacitance tends to lower a self-resonant frequency in a high-frequency range, as compared with a configuration with small stray capacitance. Therefore, a configuration with large stray capacitance tends not to reliably maintain a Q-factor in a high-frequency range. In contrast, the coil component 1 is capable of reliably maintaining a Q-factor in a high-frequency range. The high-frequency range includes, for example, 1 GHz to 30 GHz.

The coil conductor 7e disposed at the same position as the conductor portion 65 in the direction D3 may include the portion 7e₁ located closer to the end surface 3d than the plane PL3 and the portion 7e₂ located closer to the end surface 3c than the plane PL3. The conductor portion 65 may be disposed to oppose the portion 7e₁ having a length smaller than the length of the portion 7e₂.

A configuration in which the conductor portion 65 is disposed to oppose the portion 7e₁ tends to reduce an opposing area between the conductor portion 65 and the coil conductor 7e, as compared with a configuration in which the conductor portion 65 is disposed to oppose the portion 7e₂. Therefore, in the configuration in which the conductor portion 65 is disposed to oppose the portion 7e₁, this configuration suppresses an increase in stray capacitance between the external electrode 6 and the coil 7, and tends not to degrade characteristics of the coil component 1.

The coil conductors 7a, 7d, and 7g disposed at the same positions as the respective conductor portions 55 in the direction D3 may be located closer to the main surface 3b than the plane PL4.

In a configuration in which the coil conductors 7a, 7d, and 7g disposed at the same positions as the respective conductor portions 55 in the direction D3 are located closer to the main surface 3b as described above, this configuration tends to reduce the opposing area between the conductor portions 55 and the coil conductors 7a, 7d, and 7g. Therefore, this configuration suppresses an increase in the stray capacitance between the external electrode 5 and the coil 7, and tends not to degrade the characteristics of the coil component 1.

The coil conductors 7a, 7d, and 7g disposed at the same positions as the respective conductor portions 65 in the direction D3 may be located closer to the main surface 3bthan the plane PL4.

In a configuration in which the coil conductors 7a, 7d, and 7g disposed at the same positions as the respective conductor portions 65 in the direction D3 are located closer to the main surface 3b as described above, this configuration tends to reduce the opposing area between the conductor portions 65 and the coil conductors 7a, 7d, and 7g. Therefore, this configuration suppresses an increase in the stray capacitance between the external electrode 6 and the coil 7, and tends not to degrade the characteristics of the coil component 1.

The width of the conductor portion 55 in the direction D2 may decrease as distance from the main surface 3a increases.

A configuration in which the above-described width decreases as distance from the main surface 3a increases tends not to decrease the distance between the conductor portion 55 and the coil 7. Therefore, this configuration suppresses an increase in the stray capacitance generated between the external electrode 5 and the coil 7, and tends not to degrade the characteristics of the coil component 1.

The width of the conductor portion 65 in the direction D2 may decrease as distance from the main surface 3a increases.

A configuration in which the above-described width decreases as distance from the main surface 3a increases tends not to decrease the distance between the conductor portion 65 and the coil 7. Therefore, this configuration suppresses an increase in the stray capacitance generated between the external electrode 6 and the coil 7, and tends not to degrade the characteristics of the coil component 1.

The conductor portion 55 may include the surface 55aopposing the coil 7. The distance in the direction D2 between the surface 55a of the conductor portion 55 and the end surface 3c may decrease as distance from the main surface 3aincreases.

A configuration in which the above-described distance decreases as distance from the main surface 3a increase tends not to decrease the distance between the conductor portion 55 and the coil 7. Therefore, this configuration suppresses an increase in the stray capacitance between the external electrode 5 and the coil 7, and tends not to degrade the characteristics of the coil component 1.

The conductor portion 65 may include the surface 65aopposing the coil 7. The distance in the direction D2 between the surface 65a of the conductor portion 65 and the end surface 3d may decrease as distance from the main surface 3a increases.

A configuration in which the above-described distance decreases as distance from the main surface 3a increase tends not to decrease the distance between the conductor portion 65 and the coil 7. Therefore, this configuration suppresses an increase in the stray capacitance between the external electrode 6 and the coil 7, and tends not to degrade the characteristics of the coil component 1.

The external electrode 5 may include the plurality of conductor portions 55 spaced apart from each other in the direction D3.

A configuration in which the external electrode 5 includes the plurality of conductor portions 55 further increases the contact area between the external electrode 5 and the element body 3. Therefore, this configuration further improves the bonding strength between the external electrode 5 and the element body 3.

The external electrode 6 may include the plurality of conductor portions 65 spaced apart from each other in the direction D3.

A configuration in which the external electrode 6 includes the plurality of conductor portions 65 further increases the contact area between the external electrode 6 and the element body 3. Therefore, this configuration further improves the bonding strength between the external electrode 6 and the element body 3.

The external electrode 5 may include the plurality of conductor layers 15band the plurality of conductor layers 15a. The plurality of conductor layers 15aand the plurality of conductor layers 15b may be alternately disposed in the direction D3.

A configuration in which the plurality of conductor layers 15a and the plurality of conductor layers 15b are alternately disposed in the direction D3 more reliably increases the contact area between the external electrode 5 and the element body 3. Therefore, this configuration more reliably improves the bonding strength between the external electrode 5 and the element body 3.

The external electrode 6 may include the plurality of conductor layers 16band the plurality of conductor layers 16a. The plurality of conductor layers 16aand the plurality of conductor layers 16b may be alternately disposed in the direction D3.

A configuration in which the plurality of conductor layers 16a and the plurality of conductor layers 16b are alternately disposed in the direction D3 more reliably increases the contact area between the external electrode 6 and the element body 3. Therefore, this configuration more reliably improves the bonding strength between the external electrode 6 and the element body 3.

The conductor portion 55 may be located at the outermost position in the direction D3 in the external electrode 5. The conductor portion 65 may be located at the outermost position in the direction D3 in the external electrode 6.

The conductor portion 55 and the conductor portion 65 may be disposed at different positions in the direction D3.

The conductor portion 51 and the conductor portion 53 may be directly connected to each other.

A configuration in which the conductor portion 51 and the conductor portion 53 are directly connected to each other further increases the contact area between the external electrode 5 and the element body 3. Therefore, this configuration further improves the bonding strength between the external electrode 5 and the element body 3.

The conductor portion 61 and the conductor portion 63 may be directly connected to each other.

A configuration in which the conductor portion 61 and the conductor portion 63 are directly connected to each other further increases the contact area between the external electrode 6 and the element body 3. Therefore, this configuration further improves the bonding strength between the external electrode 6 and the element body 3.

It is to be understood that not all aspects, advantages and features described herein may necessarily be achieved by, or included in, any one particular example. Indeed, having described and illustrated various examples herein, it should be apparent that other examples may be modified in arrangement and detail.

The number of turns of the coil 7 is not limited to the number illustrated in the drawings. The number of the plurality of coil conductors 7a, 7b, 7c, 7d, 7e, 7f, and 7g is not limited to the number illustrated in the drawings. The number of the plurality of element body layers 13 is not limited to the number illustrated in the drawings. The shapes of the plurality of coil conductors 7a, 7b, 7c, 7d, 7e, 7f, and 7g are not limited to the shapes illustrated in the drawings. The number of the plurality of conductor layers 15 is not limited to the number illustrated in the drawings. The number of the conductor portions 55 is not limited to the number illustrated in the drawings. The shape of the conductor portion 55 is not limited to the shape illustrated in the drawings. The number of the plurality of conductor layers 16 is not limited to the number illustrated in the drawings. The number of the conductor portions 65 is not limited to the number illustrated in the drawings. The shape of the conductor portion 65 is not limited to the shape illustrated in the drawings. The number of the conductor portions 55 and the number of the conductor portions 65 may be different from each other. The shape of the conductor portion 55 and the shape of the conductor portion 65 may be different from each other.

In the present example, a coil component has been described as an example of an electronic component. However, applicable electronic components are not limited to coil components. Applicable electronic components are, for example, electronic components such as capacitor components, piezoelectric actuator components, varistor components, thermistor components, solid-state battery components, or composite components, or electronic components other than multilayer electronic components.

What is claimed is:

1. An electronic component comprising:
an element body; and
a pair of external electrodes disposed on the element body, wherein the element body includes
a first main surface arranged to constitute a mounting surface,
a second main surface opposing the first main surface,
a pair of end surfaces adjacent to both the first main surface and the second main surface, and opposing each other, and
a pair of side surfaces adjacent to both the first main surface, the second main surface, and the pair of end surfaces, and opposing each other, and
wherein each of the pair of external electrodes includes
a plate-shaped first conductor portion embedded in the element body and partially exposed at the first main surface,
a plate-shaped second conductor portion embedded in the element body and partially exposed at a corresponding end surface of the pair of end surfaces, and
at least one third conductor portion embedded in the element body, the at least one third conductor portion being continuous with the first conductor portion and the second conductor portion to couple the first conductor portion to the second conductor portion.

2. The electronic component according to claim 1, further comprising:
a coil disposed in the element body and electrically connected to the pair of external electrodes, the coil including a plurality of coil conductors.

3. The electronic component according to claim 2,
wherein a coil conductor, among the plurality of coil conductors, disposed at a same position as the at least one third conductor portion in a direction in which the pair of side surfaces oppose each other includes
a first portion located closer to one of the pair of end surfaces than a plane orthogonal to the first main surface and parallel to the pair of end surfaces, the plane including an axis of the coil; and
a second portion located closer to the other of the pair of end surfaces than the plane, and
wherein the at least one third conductor portion is disposed to oppose whichever of the first portion and the second portion has the smaller length.

4. The electronic component according to claim 2,
wherein a coil conductor, among the plurality of coil conductors, disposed at a same position as the at least one third conductor portion in a direction in which the pair of side surfaces oppose each other is located closer to the second main surface than a plane parallel to the first main surface and including an end of the at least one third conductor portion included in each of the pair of external electrodes, the end being farthest from the first main surface.

5. The electronic component according to claim 2,
wherein a width of the at least one third conductor portion in a direction in which the pair of end surfaces oppose each other decreases as distance from the first main surface increases.

6. The electronic component according to claim 2,
wherein the at least one third conductor portion includes a surface opposing the coil, and
wherein a distance, in a direction in which the pair of end surfaces oppose each other, between the surface opposing the coil in the at least one third conductor portion and the corresponding end surface decreases as distance from the first main surface increases.

7. The electronic component according to claim 1,
wherein the at least one third conductor portion includes a plurality of third conductor portions spaced apart from each other in a direction in which the pair of side surfaces oppose each other.

8. The electronic component according to claim 7,
wherein each of the pair of external electrodes includes
a plurality of first conductor layers each including a corresponding third conductor portion among the plurality of third conductor portions; and
a plurality of second conductor layers not including the third conductor portion, and
wherein the plurality of first conductor layers and the plurality of second conductor layers are alternately disposed in the direction in which the pair of side surfaces oppose each other.

9. The electronic component according to claim 1,
wherein the at least one third conductor portion is located at an outermost position in the external electrode in a direction in which the pair of side surfaces oppose each other.

10. The electronic component according to claim 1,
wherein the at least one third conductor portion included in one of the pair of external electrodes and the at least one third conductor portion included in the other of the pair of external electrodes are disposed at different positions in a direction in which the pair of side surfaces oppose each other.

11. The electronic component according to claim 1,
wherein the first conductor portion and the second conductor portion are directly connected to each other.

12. An electronic component comprising:
an element body; and
a pair of external electrodes disposed on the element body, wherein the element body includes
a first main surface,
a second main surface opposing the first main surface,
a pair of end surfaces adjacent to both the first main surface and the second main surface, and opposing each other, and
a pair of side surfaces adjacent to both the first main surface, the second main surface, and the pair of end surfaces, and opposing each other, and
wherein each of the pair of external electrodes includes
a first conductor portion embedded in the element body and partially exposed at the first main surface,
a second conductor portion embedded in the element body and partially exposed at a corresponding end surface of the pair of end surfaces, and
a plurality of third conductor portions embedded in the element body and spaced apart from each other in a direction in which the pair of side surfaces oppose each other, the plurality of third conductor portions each being continuous with the first conductor portion and the second conductor portion to couple the first conductor portion to the second conductor portion.

13. The electronic component according to claim 12,
wherein each of the pair of external electrodes includes
a plurality of first conductor layers each including a corresponding third conductor portion among the plurality of third conductor portions; and
a plurality of second conductor layers not including the third conductor portion, and
wherein the plurality of first conductor layers and the plurality of second conductor layers are alternately disposed in the direction in which the pair of side surfaces oppose each other.

14. The electronic component according to claim 12,
wherein the plurality of third conductor portions includes a third conductor portion located at an outermost position in the external electrode in a direction in which the pair of side surfaces oppose each other.

15. The electronic component according to claim 12,
wherein the plurality of third conductor portions included in one of the pair of external electrodes and the plurality of third conductor portions included in the other of the pair of external electrodes are disposed at different positions in a direction in which the pair of side surfaces oppose each other.

16. The electronic component according to claim 12, further comprising:
a coil disposed in the element body and electrically connected to the pair of external electrodes, the coil including a plurality of coil conductors.

17. The electronic component according to claim 16,
wherein a coil conductor, among the plurality of coil conductors, disposed at a same position as the third conductor portion in a direction in which the pair of side surfaces oppose each other includes
a first portion located closer to one of the pair of end surfaces than a plane orthogonal to the first main surface and parallel to the pair of end surfaces, the plane including an axis of the coil; and
a second portion located closer to the other of the pair of end surfaces than the plane, and
wherein the third conductor portion disposed at a same position as the coil conductor is disposed to oppose whichever of the first portion and the second portion has the smaller length.

18. The electronic component according to claim 16,
wherein a coil conductor, among the plurality of coil conductors, disposed at a same position as the third conductor portion in a direction in which the pair of side surfaces oppose each other is located closer to the second main surface than a plane parallel to the first main surface and including an end of the at least one third conductor portion included in each of the pair of external electrodes, the end being farthest from the first main surface.

19. The electronic component according to claim 16,
wherein a width of the third conductor portion in a direction in which the pair of end surfaces oppose each other decreases as distance from the first main surface increases.

20. The electronic component according to claim 16,
wherein the third conductor portion includes a surface opposing the coil, and
wherein a distance, in a direction in which the pair of end surfaces oppose each other, between the surface opposing the coil in the at least one third conductor portion and the corresponding end surface decreases as distance from the first main surface increases.
